(19) United States
(12) Patent Application Publication
(10) Pub. No.: US 2004/0154001 A1
(43) Pub. Date: Aug. 5, 2004

(54) Profile-guided regression testing

(76) Inventors: Mohammad R. Haghighat, San Jose, CA (US); David C. Sehr, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/358,943

(22) Filed: Feb. 5, 2003

(51) Int. Cl. G06F 9/44; H04L 1/22

(52) U.S. Cl. 717/130; 714/38

(57) ABSTRACT

A method and tool are provided to generate an ordered list of suggested tests for regression testing, given a particular change-set. The list is ordered based on priority, wherein the priority reflects the probability that a test will detect one or more errors in the software program under test. A test profile is generated for each of the tests in the regression test group, and the profile data is used to identify tests that are likely to invoke one or more components of the software program that are implicated by the given change-set. The profile data is further used to generate the priority for each of the selected tests.

### BACKGROUND

1. Technical Field

The present invention relates generally to information processing systems and, more specifically, to regression testing of multi-component software programs.

2. Background Art

A dominant testing methodology in the software industry is regression testing. Regression testing typically involves running a large number of tests to determine if a current set of changes to a software program (the set of changes being referred to as a “change-set”) causes any of the tests to regress from their correct execution. The time required to run the large number of tests for regression testing can be quite long; while some regression tests constitute an overnight job, other regression tests can require up to a week to run. This time constraint can be particularly problematic for large software development projects that require a relatively large number of incremental changes.

As stated above, a regression test usually involves running a large number of separate tests. Often, each test is in the regression test group is designed to verify the correct execution of one specific feature of the software application under test. This observation is particularly true with respect to increasingly prevalent modular and component-based software applications. Accordingly, the paths in the execution of a software application under test, with respect to a single one of the tests in the regression test group, is often a very small subset of all possible paths. In other words, the matrix of dependence relations between the software application components and related regression group tests is often extremely sparse. Accordingly, running every test in the regression test group for a given change-set may involve running many tests unnecessarily. It would be beneficial to reduce testing time by running only those tests in the regression test group that correspond to application components that are likely to be implicated by the current change-set. Embodiments of the method and apparatus disclosed herein address these and other concerns related to regression testing of multi-component software programs.

### BRIEF DESCRIPTION OF THE DRAWINGS

The present invention may be understood with reference to the following drawings in which like elements are indicated by like numbers. These drawings are not intended to be limiting but are instead provided to illustrate selected embodiments of a method and apparatus for profile-guided regression testing.

FIG. 1 is a flow diagram illustrating control flow and data flow for a method of generating an ordered list of tests for a change-set.

FIG. 2 is a flow diagram illustrating a compilation process that results in generation of profile information.

FIG. 3 is a flow diagram illustrating a method for profile registration.

FIG. 4 is a flow diagram illustrating a method for selecting and ordering suggested tests.

FIG. 5 is a block diagram illustrating a system capable of performing a method of generating an ordered list of tests for a change-set.

### DETAILED DISCUSSION

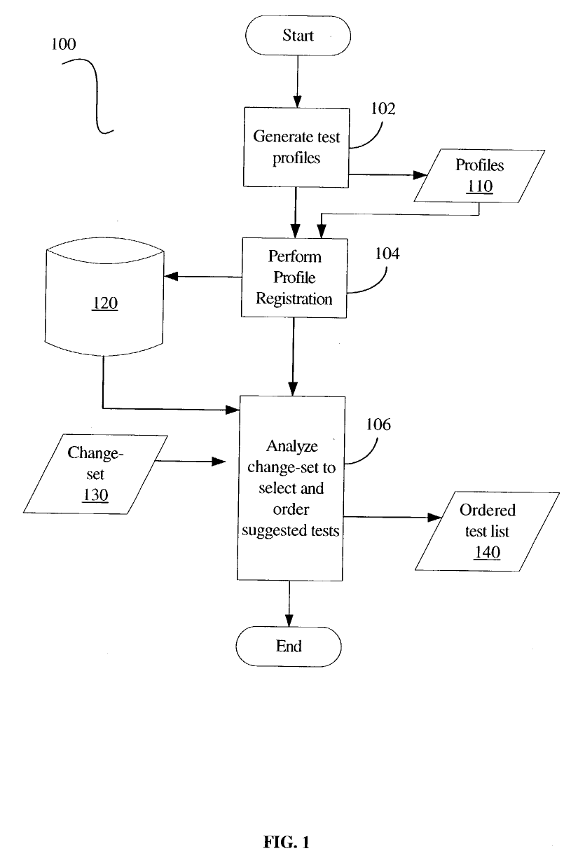

FIG. 1 is a flow diagram illustrating control flow and data flow for an automated method 100 of generating an ordered list of tests for a change-set. For a given change-set 130, the method 100 eliminates the tests from the regression test group that the method 100 determines are irrelevant for a given change-set. The method 100 prioritizes the remaining tests based on their projected probability of capturing an error in the application under test, as modified by the change-set. The method 100 generates a list of suggested tests, wherein the list is ordered such that the first-listed test has the highest projected probability of detecting an error during regression testing for the change-set.

As used herein, the term “automated” refers to an automated process wherein the method 100 is performed automatically. One skilled in the art will recognize that, in alternative embodiments, the method 100 may be performed manually. However, for at least one embodiment the method 100 is performed automatically by a compiler.

FIG. 1 illustrates that the method 100 generates a set of profiles 110, each profile corresponding to a test in the regression test group. To generate 102 the profiles 110, an instrumented version of the application is run on each of the tests.

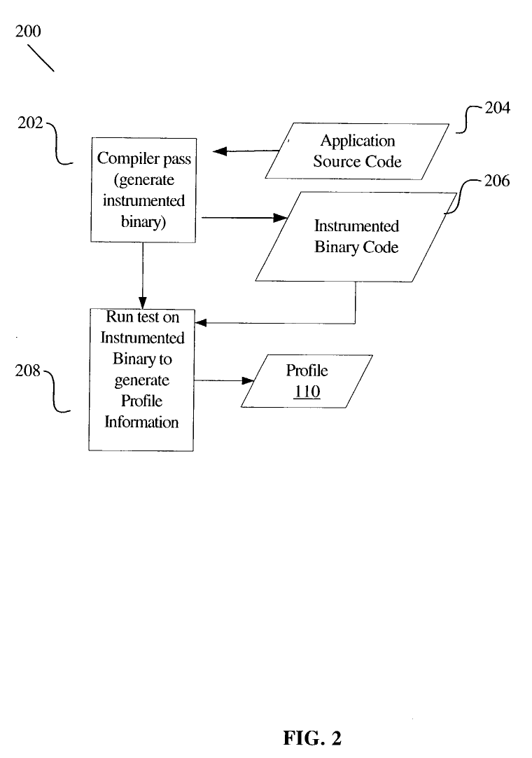

Brief reference to FIG. 2 provides background information concerning generation 102 of the profiles 110. The instrumented binary code 206 contains, in addition to the binary code for the source code 204 instructions, extra binary code that causes, during a run of the instrumented code 206, statistics to be collected and recorded in a profile 110. The instrumented code may be generated by means of a binary rewriting tool (not shown). A binary rewriting tool may create an instrumented version 206 of the application 204 by adding machine instructions at the appropriate locations in the file 206 to keep track of information regarding execution of the application 204.

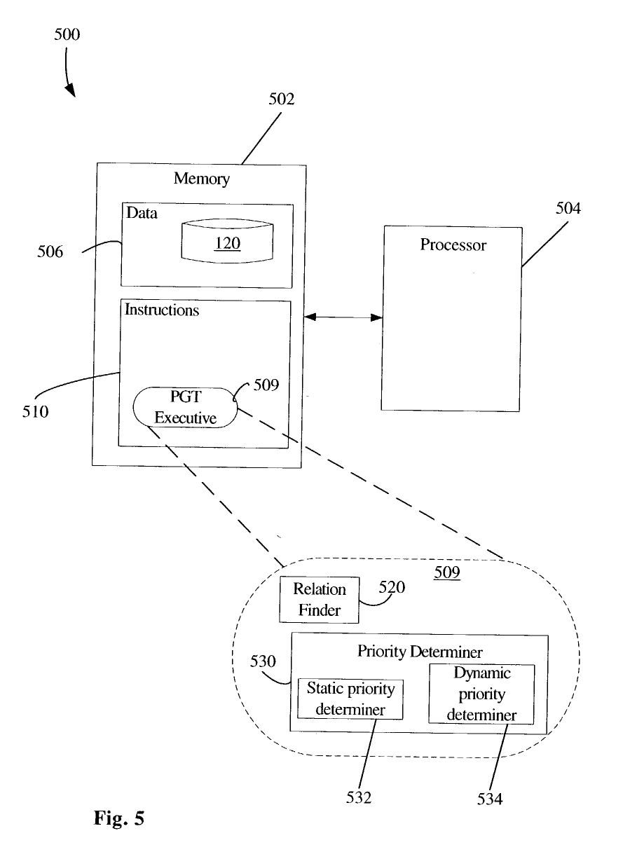

Alternatively, the instrumented binary code 206 may be generated with the help of a compiler, as illustrated in FIG. 2. During a first pass 202, the compiler (e.g., 508 in FIG. 5) receives as an input the source code 204 for which compilation is desired. The compiler then generates instrumented binary code 206 that corresponds to the source code 204. In such case, the compiler inserts probe instructions at the appropriate locations in the file 206 to keep track of information regarding execution of the application 204.

When a user initiates a test run 208 of a test against the instrumented binary code 206, a profile 110 is generated for that test. For at least one embodiment, block 102 includes performing multiple test runs 208, once for each test in the regression test group.

The instrumentation of the binary code 206 can be implemented at various granularity levels in order to capture the desired level of information in the profile files 110. For example, the instrumentation may be implemented at the procedure level or at the basic block level. If, for example, the instrumentation of the instrumented binary code 206 is implemented at the basic block level, then the profile 110 generated by a test run 208 of the instrumented code 206 will reflect which of the basic blocks of the application source code 204 were executed during the test run, and how many times each basic block was executed. If, on the other hand, instrumentation is implemented at the procedure level, then the profiles will reflect which procedures were executed, and how many times each of them was executed. One skilled in the art will recognize that other levels of granularity, such as file level granularity, may be implemented.

Returning to FIG. 1, one can see that the profiles 110 generated at block 102 are used as an input to block 104. At block 104, profile registration is performed. Profile registration 104 results in entry of information into a database 120 or other storage structure.

Utilizing profile information that has been registered in the database 120, and with reference to a given change-set 130, the method 100 analyzes 106 the change-set to select and order suggested tests. An ordered list 140 of suggested tests is generated as a result of such analysis 106. The ordered list 140 reflects, for a given change-set 130, those tests that are predicted to identify an error in the application.

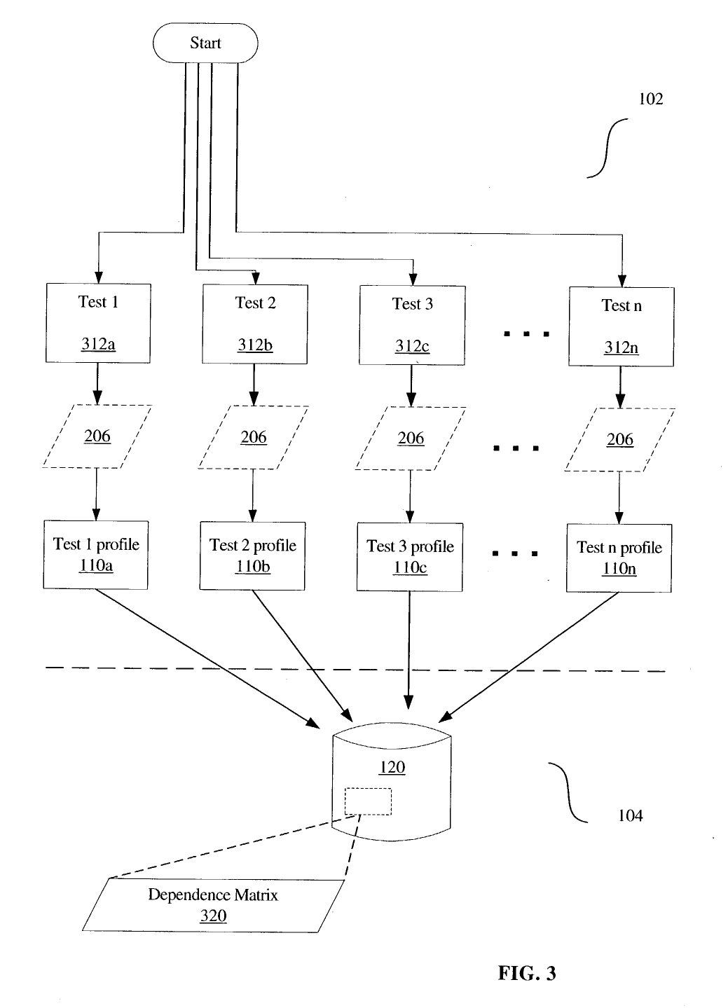

FIG. 3 is a flow diagram illustrating the profile generation 102 and profile registration 104 of FIG. 1 in further detail. FIG. 3 illustrates that each test 312a-312n in the regression test group is run on the instrumented code 206 in order to generate 102 a corresponding profile 110a-11n, respectively.

The registration 104 of a test 312 involves recording profile 110 information (such as which components are executed, and how often) for each test in a database 120, or other storage structure. For at least one embodiment, the profile information registered 104 in the database 120 is globally accessible to the testing tool (e.g. 509 in FIG. 5).

For at least one embodiment of the method 100, only selected portions of the profiles 110a-110n are extracted and maintained in the database 120. For instance, it may be that profile information for only procedures is to be maintained in the database 120, while basic-block profile information is not maintained. For any granularity chosen (such as procedure or basic block), the word “component” is used herein to generically refer to the chosen unit of granularity.

For selected embodiments, information in addition to that from the profile 110 may be maintained in the database 120. For example, analysis of profile information may result in inferences regarding paths or correlations. Such additional information may also be stored in the database 120.

At least one embodiment of registration 104 includes generation of a test-component dependence relation matrix 320 to store information from, or based on, the profiles 110a-110n. The matrix 320 is derived from the profile information 110a-110n and, for at least one embodiment, is stored in the database 120. Depending on the sparseness of the matrix 320, a manner of representing the matrix in memory (e.g., 502 of FIG. 5) may be chosen. For instance, if the matrix 320 is relatively sparse, which is most of often the case, then a linked-list representation may used to represent the matrix 320. Alternatively, if the matrix 320 is dense, a bit vector or array representation may be chosen.

Regardless of the data structure utilized to represent the matrix 320 data, the matrix 320 includes data for those program components, as indicated by a profile 110a-110n, that are invoked during the execution path of the instrumented binary 206 (FIG. 2) during a given test 310a-310n. Table 1 sets forth an illustrative example of a test-component dependence relation graph 320.

TABLE 1

| | Component 1 | Component 2 | . . . | Component n |
|---|---|---|---|---|
| Test 1 | | X₁ | | X₂ |
| Test 2 | X₃ | | | |
| . | | | | |
| . | | | | |
| . | | | | |
| Test n | | | | X₄ |

It is assumed that, if a given change-set does not include any of the components that were previously used in the execution of a test, then the change-set will likely not have an impact on the test. For example, the matrix 320 illustrated in Table 1 suggests that Component 1 is executed when Test 2 is run, but is not executed when Test 1 or Test n is run. Similarly, Component 2 and Component n are executed when Test 1 is run, but only Component n is executed when Test n is run. Accordingly, the dependence matrix 320 generated during profile registration 104 indicates whether a test invokes a particular component of the application (e.g., 204 of FIG. 2) under test. The dependence matrix 320 therefore may be used as an indicator of whether a test need be run for a given change-set, since the change-set indicates which components of the application have been altered. Testing time may be minimized by skipping tests whose profiles suggest that the tests do not depend on any of the components of the given change-set.

The “X” marks in Table 1 represent data this maintained for the test-component relationship indicated by an element of the matrix 320. In some cases, the data simply includes an indication that the component is invoked during a certain test. In such cases, for very dense matrixes, one skilled in the art will recognize that it may more efficient to record the complement set of the dependences which indicates, in effect, those components that were not executed.

In addition to dependence information, other factors may be maintained for an element in the matrix. For instance, execution time may also be considered when prioritizing which tests to run, and this information is maintained in the matrix. Also, complexity may be a factor, and complexity information may also be maintained in the matrix. That is, some tests are harder than others to debug, and this difficulty may be taken into account as well. To take complexity into account for prioritization, a user-provided complexity value for each test may be used. Alternatively, the complexity values may be dynamically generated. In the former case, failure of a user to enter complexity values may result in an assumption that complexity among tests is uniform.

For at least one embodiment, data maintained for an element of the matrix also includes frequency count information as well as dependence information. Table 2, below, sets forth an example of the type of frequency count information that is maintained in at least one embodiment of the dependence matrix 320.

TABLE 2

| Test T Profile | Static Frequency | Dynamic Frequency |
|---|---|---|
| Begin | | |
| Call P1 (f_11) | P1 = 2 | P1 (first) = f_11 |
| . . . | P2 = 1 | P1(second) = f_12 |
| Call P1 (f_12) | | P2 (first) = f_21 |
| . . . | | |
| Call P2 (f_21) | | |
| End | | |

Referring to the example shown in Table 2, assume that granularity for the instrumentation of the instrumented code 206 is at the procedure level. Table 2 represents a sample scenario wherein running 102 Test T against the instrumented code 206 has generated a profile (such as 110a-n in FIG. 3). The profile indicates that Test T includes two references to procedure P1 and one reference to procedure P2. These reference counts are referred to as static frequency, and such information is entered into the database 120 during registration 104.

In addition, the profile illustrated in Table 2 indicates that dynamic frequency counts f_{—}11 and f_{—}12 are maintained in the profile for the first and second static calls to component P1, respectively. In addition, a dynamic frequency count, f_{—}21, is also maintained for the static call to the second component, P2. These counts reflect the number of times that the corresponding static call was executed during the run of the test T against the instrumented binary 206 (FIG. 2). As such, the dynamic frequency count takes into account the dynamic run-time behavior of the test. Such information is entered into the database 120 during registration 104.

Registration 104 may be performed periodically to capture any updated dependence information generated as a result of changes to the application code as the software development process proceeds. Any reasonable interval for registration 104 may be selected, such as a one-month interval. Such subsequent registration may be performed for all tests, or may be selectively performed for those tests whose profiles are likely to change dramatically as a result of a code update that occurred subsequent to the last registration.

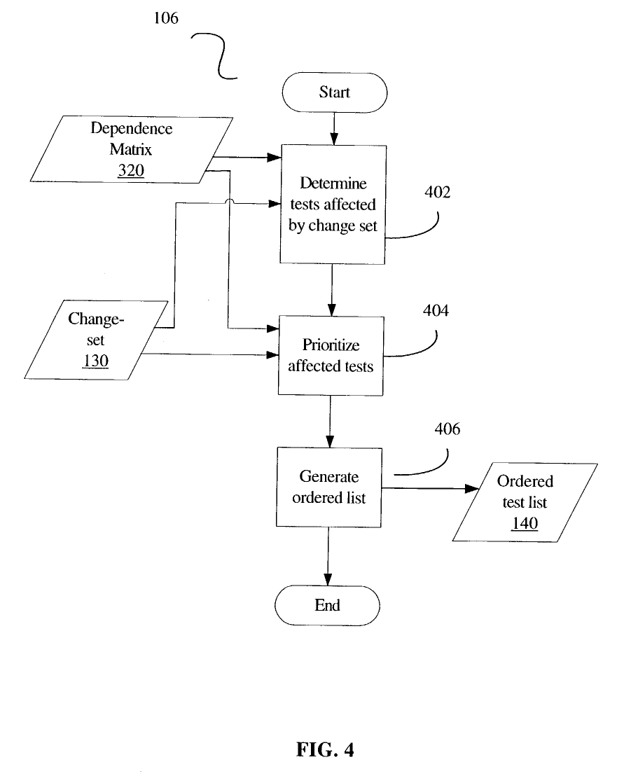

FIG. 4 is a flow diagram further illustrating at least on embodiment of a method 106 for selecting and ordering suggested tests. At block 402, the method 106 determines from the dependence matrix 320 which tests in the regression test group could be affected by the given change-set 130. Formally, the set of such tests is the union of all tests that are dependent on at least one of the components of the change-set. For example, referring to the example set forth above in Table 1, if the change-set 130 includes only changes to Component 1 and Component 2, then the group of tests identified at block 402 would include Test 1 and Test 2 but would not include Test n.

FIG. 4 illustrates that the group of tests identified at block 402 (the group being referred to below as the “identified test group”) are then prioritized 404. During at least one embodiment of prioritization 404, a prioritization computation is performed for each test in the identified test group. The priority assigned to a test reflects the predicted probability that the test will detect an error during testing for the change-set. For at least one embodiment, the prioritization 404 includes computation of both a static priority and a dynamic priority for each of the tests in the identified test group. Alternative embodiments may include computation of only one or the other of static and dynamic priorities. In addition, the computation may take into account one or more other factors, including execution time and complexity, as discussed above.

Reference is made to Table 2, above, for further discussion of dynamic and static priority as computed during prioritization 404. For purposes of discussion, it is assumed that no other component of change-set S is reflected in the profile 110 other than P1 and P2. Because two static references to P1 occur within Test T and one static reference to P occurs within Test T, the static priority of T for change-set S can be calculated 404 as 2+1=3.

As stated above, dynamic frequency counts reflect the number of times that the corresponding static call was executed during the run of the test T against the instrumented binary 206 (FIG. 2). The dynamic priority for T with respect to S can be calculated 404 as f_{—}11+f_{—}12+f_{—}21.

If a test's coverage does not include any of the components reflected in the change-set S, then both the static and dynamic priorities for the test, with respect to change-set S, may be computed 404 to be zero.

For at least one embodiment, the prioritization 404 further includes sorting the tests of the identified test group that have a non-zero priority. Such tests may be sorted based on their priority values to generate 406 an ordered list 140. The list 140 suggests the order in which tests of the regression test group should be run in order to enhance the probability of detecting an error related to the change-set 130. The ordering reflects the notion that, given two tests T1 and T2, if test T1 exercises a larger path of the application relevant to a change-set than does T2, then T1 has a higher probability than T2 of detecting an error related to the change-set. For at least one embodiment, tests are listed in the ordered list 140 in decreasing probability of detecting errors.

It should be noted that one or the other of the static and dynamic priority computations for the prioritization 404 may be disregarded for selected embodiments. That is, a user may determine that prioritization should be based on both types of priority, with one of the priority values being a secondary sort parameter. Alternatively, it could be determined that only one priority value, either static or dynamic, should be used. In such case, the other (i.e., non-selected) priority computation need not be performed during prioritization 404.

In the preceding description, various aspects of a method for generating an ordered list of tests for regression testing of a change-set have been described. In sum, the methods provide for regression testing that is guided by the profile of the application under test. Test profiles are registered in a database after running the tests on the instrumented application. When a set of components in the application is changed, as reflected by a change-set, the system analyzes the change-set using the profile information stored in the database, and generates an ordered list of tests that have relatively high probabilities of catching errors in the components of the given change-set. For purposes of explanation, specific numbers, examples, systems and configurations were set forth in the preceding description in order to provide a more thorough understanding. However, it is apparent to one skilled in the art that the described methods may be practiced without the specific details. In other instances, well-known features were omitted or simplified in order not to obscure the method.

Embodiments of the method 100 may be implemented in hardware, software, firmware, or a combination of such implementation approaches. Software embodiments of the method 100 may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the dynamic method described herein is not limited in scope to any particular programming language. In any case, the language may be a compiled or interpreted language

The programs may be stored on a storage media or device (e.g., hard disk drive, floppy disk drive, read only memory (ROM), CD-ROM device, flash memory device, digital versatile disk (DVD), or other storage device) readable by a general or special purpose programmable processing system. The instructions, accessible to a processor in a processing system, provide for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

An example of one such type of processing system is shown in FIG. 5. System 500 may be used, for example, to execute the processing for a method of generating a profile-based ordered list of test for regression testing, such as the embodiments described herein. System 500 is representative of processing systems based on the Pentium®, Pentium® Pro, Pentium® II, Pentium® III, Pentium® 4, and Itanium® and Itanium® II microprocessors available from Intel Corporation, although other systems (including personal computers (PCs) having other microprocessors, personal digital assistants and other hand-held devices, engineering workstations, set-top boxes and the like) may also be used. In one embodiment, sample system 500 may be executing a version of the Windows™ operating system available from Microsoft Corporation, although other operating systems and graphical user interfaces, for example, may also be used.

Referring to FIG. 5, processing system 500 includes a memory system 502 and a processor 504. Memory system 502 is intended as a generalized representation of memory and may include a variety of forms of memory, such as a hard drive, CD-ROM, random access memory (RAM), dynamic random access memory (DRAM), static random access memory (SRAM) and related circuitry.

Memory system 502 may store instructions 510 and/or data 506 represented by data signals that may be executed by processor 504. The instructions 510 and/or data 506 may include code for performing any or all of the techniques discussed herein. For an embodiment wherein the method 100 is performed by a software tool, instructions 510 may include a program 509, referred to herein as a Profile-Guided Testing (“PGT”) Executive tool program.

FIG. 5 illustrates that the instructions implementing an embodiment 100 of the method discussed herein may be logically grouped into various functional modules. For an embodiment performed by a PGT Executive tool program 509, the tool program 509 may include a relation finder 520, and a priority determiner 530.

When executed by processor 504, the relation finder 520 determines relationships between tests and application components affected by a given change set, as discussed above in connection with FIGS. 1 and 3.

The priority determiner 530, when executed by the processor 504, analyzes a change set to select, prioritize, and order suggested tests and generate an ordered list as described above in connection with FIGS. 1 and 4.

While particular embodiments of the present invention have been shown and described, it will be obvious to those skilled in the art that changes and modifications can be made without departing from the present invention in its broader aspects. The appended claims are to encompass within their scope all such changes and modifications that fall within the true scope of the present invention.

What is claimed is:

1. A method comprising:
identifying a plurality of tests to determine an identified test group;
automatically assigning a priority to each test in the identified test group, wherein the priority reflects the probability that the associated test will detect an error in the execution of a software application; and
ordering, based on priority, the tests in the identified test group;
wherein identifying a plurality of tests further includes determining, for each of a plurality of candidate tests, whether, based on a profile associated with the candidate test, the candidate test invokes one or more of a plurality of components of the software application, the plurality of components being associated with a change-set and, if so, including the candidate test in the identified test group.

2. The method of claim 1, wherein:
the priority further reflects the complexity of the associated test.

3. The method of claim 1, wherein:
the priority further reflects the execution time of the associated test.

4. The method of claim 1, further comprising:
generating the profile for each candidate test by running each candidate test on instrumented version of the software application.

5. The method of claim 1, further comprising:
registering the profile for each candidate test in a database.

6. The method of claim 1, further comprising:
generating an ordered list of the tests included in the identified test group.

7. The method of claim 1, further comprising:
generating a dependence matrix to reflect dependence relationships between the plurality of components and the plurality of candidate tests.

8. The method of claim 7, further comprising:
maintaining the dependence matrix in the database.

9. The method of claim 1, further comprising:
maintaining frequency information in the database.

10. The method of claim 9, wherein:
maintaining frequency information further comprises maintaining one or more static frequency count values.

11. The method of claim 9, wherein:
maintaining frequency information further comprises maintaining one or more dynamic frequency count values.

12. An article comprising:
a machine-readable storage medium having a plurality of machine accessible instructions;
wherein, when the instructions are executed by a processor, the instructions provide for identifying a plurality of tests to determine an identified test group;
assigning a priority to each test in the identified test group, wherein the priority reflects the probability that associated test will detect an error in the execution of a software application; and
ordering, based on priority, the tests in the identified test group;
wherein the instructions that provide for identifying a plurality of tests further include instructions that provide for determining, for each of a plurality of candidate tests, whether, based on a profile associated with the candidate test, the candidate test invokes one or more of a plurality of components of the software application, the plurality of components being associated with a change-set and, if so, including the candidate test in the identified test group.

13. The article of claim 12, wherein the instructions that provide for assigning a priority further comprise:
instructions that provide for assigning a priority that further reflects the complexity of the associated test.

14. The article of claim 12, wherein the instructions that provide for assigning a priority further comprise:
instructions that provide for assigning a priority that further reflects the execution time of the associated test.

15. The article of claim 12, wherein:
the instructions further provide for generating the profile for each candidate test by running each candidate test on an instrumented version of the software application.

16. The article of claim 12, wherein:
the instructions further provide for registering the profile for each candidate test in a database.

17. The article of claim 12, wherein:
the instructions further provide for generating an ordered list of the tests included in the identified test group.

18. The article of claim 12, wherein:
the instructions further provide for generating a dependence matrix to reflect dependence relationships between the plurality of components and the plurality of candidate tests.

19. The article of claim 18, wherein:
the instructions further provide for maintaining the dependence matrix in the database.

20. The article of claim 12, wherein:
the instructions further provide for maintaining frequency information in the database.

21. The article of claim 20, wherein:
the instructions that provide for maintaining frequency information further provide for maintaining one or more static frequency count values.

22. The article of claim 20, wherein:
the instructions that provide for maintaining frequency information further provide for maintaining one or more dynamic frequency count values.

23. A software tool, comprising:
a relation finder to identify, based on profile information, a plurality of tests, wherein each of the identified tests invokes one or more software program components associated with a change-set; and
a priority determiner to a assign a priority to each of the identified tests and to order the identified tests according to the priorities, wherein the priority assigned to an identified test reflects the probability that the identified test will detect an error in the software program.

24. The tool of claim 23, wherein:
the priority determiner is further to generate an ordered list of the identified tests, wherein the order of the list is based on the priorities of the identified tests.

25. The tool of claim 23, wherein:
the relation finder is further to identify the plurality of identified tests from among a plurality of candidate tests, wherein the profile information includes a test profile for each of the candidate tests.

26. The tool of claim 23, wherein:
the relation finder is further to access the profile information via a database.
